(19) United States
(12) Patent Application Publication
(10) Pub. No.: US 2009/0139368 A1
(43) Pub. Date: Jun. 4, 2009

(54) SHAFT WITH FIXED COMPONENT

(75) Inventor: Wolfgang Mayer, Gronsdorf (DE)

Correspondence Address: HENKEL CORPORATION, 1001 TROUT BROOK CROSSING, ROCKY HILL, CT, 06067, US

(73) Assignee: HENKEL AG & CO.KGaA, DUESSELDORF (DE)

(21) Appl. No.: 12/330,940

(22) Filed: Dec. 9, 2008

Related U.S. Application Data
(63) Continuation of application No. PCT/EP2007/055588, filed on Jun. 6, 2007.

(30) Foreign Application Priority Data
Jun. 14, 2006 (DE) 102006027494.6

(51) Int. Cl. F01L 1/047; F16H 53/00; B23P 15/00

(52) U.S. Cl. 74/567; 29/888.08

(57) ABSTRACT

Shaft with a fixed component, where the connection between the shaft body and the component is provided via combined cohesion and interlock. The interlock is achieved by way of example via profiling of the components, and permits correct positioning of the component on the shaft body in a radial direction with respect to the shaft body. The cohesion is provided by means of an adhesive layer composed of high-strength structural adhesive, by way of a jointing method that avoids any substantial heating. The cohesive connection fixes the component on the shaft body in an axial direction with respect to the shaft body. Under operating conditions, forces acting on the component are therefore transmitted both by way of the cohesive connection and also by way of the interlock connection.

### CROSS REFERENCE TO RELATED APPLICATIONS

This application is a continuation of international application PCT/EP2007/055588, filed on Jun. 6, 2007, which claims the benefit of German application DE 10 2006 027 494.6, filed Jun. 14, 2006, the contents of each of which are incorporated herein by reference in their entirety.

### FIELD

The disclosure relates to a shaft with a fixed component. These types of shaft are particularly employed as camshafts for e.g. internal combustion engines for controlling valves. However, the disclosure relates not only to camshafts but can find use wherever its application yields advantages in cost and quality in construction and manufacture.

### BACKGROUND

In the prior art, camshafts are known that are integrally formed from cast iron or clear chilled casting. However, these components have the disadvantage that costly and time consuming machining steps, such as cam grinding, heat treatment and straightening have to be carried out from the production of the raw product to the fully finished camshaft. A further production process is the manufacture of a multi-piece camshaft. Such camshafts are called worked camshafts. The shaft body and the cam are produced by separate techniques. The essentially finished cams can then be fixed on the shaft body. A worked camshaft of this type is described in DE 4121951 C1. Here the shaft body and the cams are manufactured separately. Sections of the shaft body, onto which the cams can be slipped on, have a larger diameter than in other regions. The cam is fixed onto the shaft body by a force fit or friction lock between the sections of enlarged diameter of the shaft body and the cams. The disadvantage of this production process, however, is correctly positioning the cam in the radial direction in regard to the camshaft body. An incorrect positioning of the cams with respect to one another can have far reaching effects, particularly for internal combustion engines, as even for a very slight deviation of the position of the cams, the control of the valves of the internal combustion engine in particular can no longer be guaranteed. Other force fit or friction locking joints are also known from the prior art. A known method is the production of the joint between component and shaft by means of a cylindrical interference fit assembly. However, this is a laborious and cost-intensive method. Moreover, a hollow shaft body with an appropriate wall thickness must be used. A plastic deformation can arise with hollow shaft bodies that have too thin walls.

Cohesive joints for shafts with components are also known, for example by using adhesive. However, these joints were not able to gain acceptance, especially for camshafts, due to the poor long-term resistance of the joint under the influence of heat and oil. If, for example an internal combustion engine comes to a state of rest, on which a cam of the camshaft remains under load, then the adhesive tends to creep and can lead to a radial movement of the cam relative to the shaft body. This situation is even intensified by the usual high temperatures in the internal combustion engine and the presence of oil. In this case, an error-free, fresh start up of the internal combustion engine would no longer be guaranteed.

DE 2838995 shows a worked camshaft, whereby the cams are radially fixed by means of fluting. The cam is solidly joined with the shaft body to its designated position by brazing. With this variant, the influence of heat on the material from brazing is disadvantageous. This jointing technology causes high concentrations of stress at the joints, thereby limiting the load tolerance of the entire camshaft. This disadvantage also results with other joining techniques for both components in which heat is given off, such as for example sintering or welding. In order to balance the high stress concentrations, additional cost-intensive treatment steps are required for the camshaft, such as for example annealing or stress-free annealing, which limit the operating efficiency of the method.

### SUMMARY

Accordingly, the object is to provide an improved and more cost effective generic device that does not exhibit the above described disadvantages.

This object is achieved by means of the features of claim 1.

Advantageous developments are indicated with the dependent claims.

The fundamental idea comprises producing the joint between a shaft body and a component by a combination of cohesive joining and mechanical interlocking, wherein the cohesion is provided by means of a high strength structural adhesive by a jointing method that avoids any substantial heating. For example, the cohesive joint can fix the component on the shaft body in an axial direction with respect to the shaft body. It is conceivable to design the shaft body with a particular profile, such as for example an elliptical profile, a polygon profile or with one or more grooves or projections. In this case the component being fixed possesses an appropriate internal profile or one or more protrusions that mesh with the corresponding matching part of the shaft body. In this way, the shaft body and the component can be designed and manufactured independently and assembled by pushing the component over the shaft body to the desired axial position on the shaft wherein the profiles of the component and shaft mechanically interlock the rotational position of both the components to each another. Naturally, other types of interlocking joints are also conceivable, such as for example seat-engaging joints or splined joints. An interlocking joint that is symmetrical to the shaft axis is advantageous in order that the forces to be transmitted are evenly distributed. After a preferably correct positioning by a mechanical interlocking joint of the component, the strong final joint of the shaft body and component results from cohesion by means of a jointing method that avoids any substantial heating. High strength structural adhesives are used for this. This cohesive joint preferably fixes the component on the shaft body in the axial direction with respect to the shaft body and additionally reinforces the interlocking joint to help prevent movement of the component and shaft body in the radial direction. Under operating conditions, the forces acting on the component are consequently transmitted over both the cohesive joint as well as over the interlocking mechanical joint.

The known high-strength structural adhesives are suitable adhesives. In particular, they are chosen from 1 or 2 component adhesives based on crosslinking polyurethanes, epoxy resins and/or anaerobically crosslinking acrylate-containing adhesives. Temperature-stable polyimide adhesives can also be employed. The adhesives should be stable against temperatures and solvents under the conditions of application. Epoxy resin adhesives are understood to mean adhesives based on epoxide group-containing oligomers or polymers, which can be crosslinked with nucleophilic or electrophilic curing agents, such as for example polyamines, polyamides, polymercaptans, polyols or polyphenols. Anaerobic curing adhesives are understood to mean those that comprise oligomers or polymers containing double bonds, such as for example acrylate groups, and wherein the radical crosslinking is initiated by activator/initiator systems, and activated under anaerobic conditions. Redox systems are known activators; in particular metal-containing systems are suitable. Polyurethane adhesives are understood to mean reactive adhesives based on isocyanate group-containing polyurethanes, which can be present as 2-K systems or as 1-K systems. 1-K systems crosslink, for example with water or latent curing agents are activated under the action of heat. With 2-K systems, isocyanate-containing prepolymers are treated with curing agents that comprise isocyanate-reactive groups, such as for example OH, NH, SH, COOH groups.

Suitable adhesive systems are described for example in the Encyclopedia of Polymer Science and Technology (pub. Wiley, 2005) in the chapter “Structural adhesives”. Adhesives of this type can be mixed with additional known auxiliaries and additives, for example catalysts, fillers, reactive diluents, coupling agents, by which, properties of the adhesive can be specifically influenced.

As the adhesive layer is mainly subjected to shear during operation of the shaft, the gap between component and shaft body in which is found the high-strength structural adhesive layer is kept as small as possible. The use of a gap size of below 500 μm between the component and the shaft body has proven advantageous. This prevents the adhesive from being sheared off by the forces acting on the component under the operating conditions, and the cohesive joint from being destroyed.

Both solid as well as hollow camshafts are considered in the scope of the disclosure. In an advantageous development, it is intended to allow for a hollow shaft as the shaft body. In this way, weight savings, for example, can be made, which is of great advantage—particularly for use in internal combustion engines. Here, the hollow shaft can also be used, especially for oil transport. Consequently, as with solid shaft bodies, very high dynamic torques can be likewise transmitted. In the scope of the present disclosure, the shaft body can consist of metallic or non-metallic materials, in particular iron-carbon material, alloyed or unalloyed iron, lamellar or spheroidal graphite iron, cast steel or injection molding as well as a material appropriate to the application needs of the shaft.

A further advantage is the use of a shaft body as the hollow shaft with means for compensating an out of balance. Here, in the above manner the shaft body can be shaped and vibrationally engineered and balanced during production. A cast shaft body for example is conceivable here, which in areas exhibits a smaller or larger wall thickness in the form of recesses or bulges. Consequently, already in this first production step of the shaft body, the shaft can be produced and correspondingly balanced to meet the specified vibrationally engineered features. Alternatively or additionally, a corresponding inner profile is conceivable for the shaft body designed as a hollow shaft, in accordance with the external profile required for the interlocking joint with the components. For example, if the external profile of the shaft body is shaped as a polygon profile then it is advantageous to design the inner profile as the inverse of the external profile of the shaft body.

It is foreseen to produce the shaft body and the components from the same material. This simplifies for example the production and machining, particularly for simple, less loaded shaft-component systems, because the characteristics and properties of different materials need not be taken into account.

A further advantage is the finishing of shaft body and at least one component from different materials. For example, high-quality and/or appropriate materials, which better withstand the load demands, can be employed for the components joined to the shaft body. Here for example, the shaft body and/or less loaded components can be fabricated from cheaper and/or more easily machinable materials, such that further potential savings can be achieved for a simultaneous higher load capacity. In particular, extremely wear resistant ball bearing steels, cast steel, cast ceramic or sintered materials can be employed for the highly loaded components.

A further advantage is the use of components made from sintered materials. By using sintered components and particularly when appropriately accurate production of the components and the shaft body as well as correspondingly precise assembly is carried out, additional machining steps for the shaft can be obviated, such as for example polishing processes. Components of any shape can be produced by sintering and are ready for assembly without the need for any mechanical post treatment. An example is the use of the component and the shaft body in a camshaft with a profiled shaft body, for example an oval, an ellipse or a polygon. By means of the sintering technology, the openings of the components, such as for example cams or other control elements, with which these are pushed onto the shaft body, can be designed according to the profile of the shaft body and according to the radial position on the shaft body with respect to the axis of the shaft body. Additional advantageous methods of production of the components can be sinter forging, casting or forging.

It is foreseen to produce the shaft body and the component with different specifications. For example, the shaft body can be hardened to one specification to enhance toughness and better resist torsional forces while the component can be hardened to a different specification to enhance hardness and better resist wear.

In an advantageous development, the shaft concerns a camshaft, such as can be used for example in internal combustion engines. Here, the shaft body can be a camshaft tube and the components can be for example cams, chain wheel retainers, thrust bearings, thrust bearing collars, signal transmitters, disks and/or gear wheels.

### BRIEF DESCRIPTION OF THE DRAWINGS

Some possible embodiments of the disclosure will be described below in more detail with the help of drawings.

FIG. 1 shows a side view, partly in section, of one embodiment of a shaft with components.

FIG. 2 shows an end view of one embodiment of a shaft with component in cross section.

### LIST OF REFERENCE NUMERALS

1. Camshaft
2. Shaft body
3. Cam
4. Adhesive layer
5. Recess
6. Dent
7. Projection
8. Recess

### DETAILED DESCRIPTION

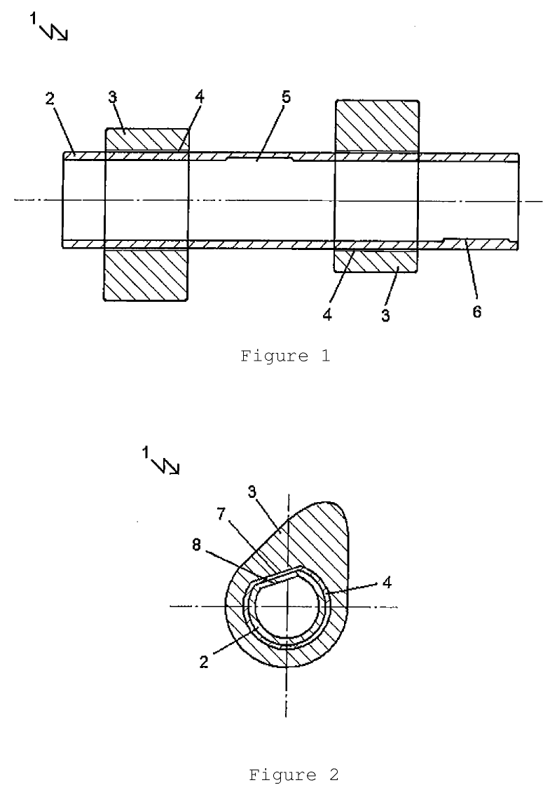

A detail of one embodiment of a shaft illustrated in FIGS. 1 and 2 used as a worked camshaft is denoted with 1. The camshaft 1 possesses a shaft body 2 that is formed as a hollow shaft tube. The shaft body 2 is preferably manufactured from a steel tube. Separately manufactured cams 3 are fixedly joined to the shaft body 2. Advantageously, the gap between the shaft body 2 and cam 3 in the joined area is no more than 500 μm. Engagement of the cam 3 with the shaft body 2 results from an interlocking joint clarified in FIG. 2, as well as from a cohesive joint by means of an adhesive layer 4 bonding the shaft body 2 to the cam 3. For the adhesive layer, an anaerobically curing adhesive is employed as the high-strength structural adhesive in the present embodiment. Nonetheless, a one or two component epoxy resin adhesive or a polyurethane adhesive can also be employed. Generally, to complete the camshaft 1, additionally further not illustrated components are positioned on the camshaft 1, such as for example a hub, chain wheel retainer, a thrust bearing with collar and mostly an asymmetrical position generator and/or additional control elements. In order to provide a camshaft 1 that has been optimally balanced from the vibrational engineering point of view, recesses 6 and dents 5 are provided on the inner side of the shaft body 2 formed as the hollow shaft tube. As illustrated in the present embodiment, these can be located both on the inner surface as well as on the external surface of the hollow shaft tube 2. For the illustrated variant, the use of for example a hollow cast shaft body 2 is advantageous, such that recesses and dents 5, 6 are already provided during the production of the shaft body 2, thereby enabling the shaft body 2 to be vibrationally balanced according to the preceding manner.

FIG. 2 shows one embodiment of a camshaft 1 in cross section through the shaft body 2 and the cam 3. The shaft body 2 possesses a recess 8. This recess is designed in such a way that when assembling cams 3 and shaft body 2, a projection 7 provided on the inner surface of the cam 3 can engage into this recess. An interlocking joint is thereby produced between shaft body 2 and cam 3. The interlocking joint shown in the embodiment can of course also be realized by means of other shapes. A polygon shaped profile of the shaft body 2 and a corresponding profile of the opening of the cam 3 would be conceivable here, with which the cam 3 is pushed onto the shaft body 2. The inner surface of the opening of the cam 3 can also have one or more protruding spurs that engage into corresponding slits in the external surface of the shaft body 2. The cam 3 is correctly positioned in the radial direction with respect to the shaft body 2 by this interlocking joint. The different phasings of a plurality of cams fixed on the shaft body 2 can be already determined when manufacturing a cam 3. The projections 8 of the cams 3 corresponding to the desired phasing at various places are preferably formed on the opening of the cams 3. The cams 3 are preferably produced in a sintering process and provided with the corresponding shape according to the predetermined phasing. In addition, the camshaft 1 possesses a cured adhesive layer between cam 3 and the shaft body 2 forming a cohesive joint 4 therebetween. This cohesive joint 4 serves for the fixing the cam 3 in the axial direction with respect to the shaft body 2 and additionally in the radial direction to the interlocking joint.

The camshaft 1 is assembled by pushing the cam 3 on the shaft body 2 in the predetermined angular position with respect to the shaft axis. The shaft body 3 can possess any profile matched to the scope of application and the opening of the cam 3 is respectively inversely profiled thereto. The application of the adhesive for the adhesive layer between cam 3 and the shaft body 4 can be made, particularly when using a free-flowing, low viscosity adhesive, only when the cam 3 has reached the predetermined position on the shaft body 2. Nevertheless it is conceivable, particularly with a higher viscosity adhesive, to apply it before reaching the predetermined position of cam 3. This is possible both on the outer surface of the shaft body 2 as well as on the inner surface of the opening of the cam 3. In this way, an evenly applied adhesive can be provided when pushing the cam 3 onto the shaft body 2. Moreover, the adhesive layer 4 in the uncured state can act as a lubricating film, which facilitates the joining of cam 3 and shaft body 2. The assembled camshaft is exposed to conditions appropriate to cure the applied adhesive, thereby forming the cohesive joint 4 between the shaft body 2 and the cam 3. Besides the cams 3, the camshaft 1 can include additional components such as for example cams, chain wheel retainers, thrust bearings, thrust bearing collars, signal transmitters or the like. These additional components may be formed integrally with the shaft body or formed separately and cohesively bonded to the shaft body 2 as described above.

While preferred embodiments have been set forth for purposes of illustration, the foregoing description should not be deemed a limitation of the disclosure herein. Accordingly, various modifications, adaptations and alternatives may occur to one skilled in the art without departing from the spirit and scope of the present disclosure.

1. A shaft with a shaft body and at least one component fixed thereon, wherein the joint of the component with the shaft body is produced by a mechanically interlocking joint and by a cohesive joint formed by a high-strength structural adhesive between the shaft body and the component.

2. The shaft according to claim 1, wherein the component is radially positioned by the interlocking joint on the shaft body.

3. The shaft according to claim 1, wherein the component is axially fixed by the cohesive joint on the shaft body.

4. The shaft according to claim 1, wherein an epoxy resin adhesive is used as the high-strength adhesive for the cohesive joint.

5. The shaft according to claim 1, wherein an anaerobically curing adhesive is used as the high-strength adhesive for the cohesive joint.

6. The shaft according to claim 1, wherein a polyurethane is used as the high-strength adhesive for the cohesive joint.

7. The shaft according to claim 1, wherein the size of the gap between component and the shaft body is less than or equal to 500 μm.

8. The shaft according to claim 1, wherein the shaft body is a hollow shaft tube.

9. The shaft according to claim 1, wherein the shaft body is a hollow shaft tube, and the shaft is rotationally balanced by provision of a plurality of recesses and bulges defined on the shaft body.

10. The shaft according to claim 1, wherein the shaft body and the component consist of the same material.

11. The shaft according to claim 1, wherein at least one component is produced from a different material than the shaft body.

12. The shaft according to claim 1, wherein at least one component consists of sintered material or sintered forged material or cast material or forged material.

13. The shaft according to claim 1, wherein the component is selected from a bearing, a control element, a cam, a hub or a gear wheel.

14. An assembly, comprising:
a shaft having a shaft body extending longitudinally between first and second ends, the shaft body comprising a first shaft interlocking portion at a predetermined axial position on the shaft body;
a first component defining an aperture therein, the aperture allowing the first component to move longitudinally along the shaft body from an end to the first shaft interlocking portion, the aperture having a component interlocking portion, wherein the component interlocking portion is mechanically interlocked with the first shaft interlocking portion to maintain the first component in a fixed rotational relationship with the shaft; and
cured reaction products of a high-strength adhesive bonding the first shaft interlocking portion and the component interlocking portion.

15. The assembly of claim 14, wherein the component is axially fixed to the shaft body by the cured reaction products.

16. The assembly of claim 14 wherein the shaft includes a second shaft interlocking portion at a predetermined axial position on the shaft body and spaced from the first shaft interlocking portion; the assembly comprising a second component defining an aperture therein, the aperture allowing the second component to move longitudinally along the shaft body from an end to the second shaft interlocking portion, the aperture having a component interlocking portion, wherein the component interlocking portion is mechanically interlocked with the second shaft interlocking portion to maintain the second component in a fixed rotational relationship with the shaft, wherein the second component rotational relationship is different than the first component rotational relationship; and
cured reaction products of a high-strength adhesive bonding the second shaft interlocking portion and the second component interlocking portion.

17. The assembly of claim 14 wherein the shaft includes a second shaft interlocking portion at a predetermined axial position on the shaft body and spaced from the first shaft interlocking portion; the first component is selected from a bearing, a control element, a cam, a hub, a gear and a sensor; the assembly comprises a second component selected from a bearing, a control element, a cam, a hub, a gear and a sensor and defining an aperture therein, the aperture allowing the second component to move longitudinally along the shaft body from an end to the second shaft interlocking portion, the aperture having a component interlocking portion, wherein the component interlocking portion is mechanically interlocked with the second shaft interlocking portion to maintain the second component in a fixed rotational relationship with the shaft, wherein the second component rotational relationship is different than the first component rotational relationship; and
cured reaction products of a high-strength adhesive bonding the second shaft interlocking portion and the second component interlocking portion.

18. An internal combustion engine camshaft comprising the assembly of claim 16.

19. An internal combustion engine camshaft comprising the assembly of claim 16, wherein the shaft interlocking portions each have a cross sectional shape selected from oval, elliptical, polygonal and D.

20. A method of making an internal combustion engine camshaft comprising the assembly of claim 16, including:
providing the shaft having the first and second shaft interlocking portions axially spaced thereon;
providing the first and second components;
disposing high-strength adhesive onto at least one of the first shaft interlocking portion, the second shaft interlocking portion, the first component interlocking portion or the second component interlocking portion;
mechanically interlocking the first component interlocking portion with the first shaft interlocking portion to rotationally fix the first component to the shaft;
mechanically interlocking the second component interlocking portion with the second shaft interlocking portion to rotationally fix the second component to the shaft; and
exposing the shaft and mechanically interlocked first and second components to conditions appropriate to cure the high-strength adhesive thereby forming cured reaction products between the shaft interlocking portions and the component interlocking portions.
